(19) United States
(12) Patent Application Publication
(10) Pub. No.: US 2002/0113013 A1
(43) Pub. Date: Aug. 22, 2002

(54) Aeration system for wastewater

(76) Inventors: David G. Long, Fairport, NY (US); Klaus E. T. Siebert, Pittsford, NY (US)

Correspondence Address: Eugene S. Stephens, Eugene Stephens & Associates, 56 Windsor Street, Rochester, NY, 14605, US

(21) Appl. No.: 09/792,250

(22) Filed: Feb. 22, 2001

(51) Int. Cl. C02F 3/02

(52) U.S. Cl. 210/620; 210/242.2; 210/209

(57) ABSTRACT

A wastewater aerating system uses a plurality of aeration floats movably arranged within a body of wastewater and supplies each of the floats with compressed air delivered through a flexible line from a compressor arranged onshore near the wastewater body. Each aeration float has a floatation chamber floating on the surface of the wastewater and delivers compressed air from the floating chamber downward to a predetermined depth below the waste water surface where the compressed air is distributed to a plurality of diffusers arranged around the surface float to direct streams of air bubbles up through the wastewater to the wastewater surface around the surface float. This nourishes aerobic bacteria, which then consume materials within the wastewater.

### TECHNICAL FIELD

Wastewater aeration systems.

### BACKGROUND

Aeration of wastewater produces known benefits. Adding oxygen to wastewater helps aerobic bacteria grow and consume materials in the water without producing offensive odors that are associated with the activities of anaerobic bacteria. Wastewater can be aerated by pumping it in fountains that expose the water to ambient air above a water surface and by pumping air or oxygen into a body of wastewater below the water surface. The fountain alternative consumes significant amounts of energy and is not cost effective, and pumping air into the wastewater is preferred for being less expensive.

One way to pump air into wastewater is to use floats such as suggested in U.S. Pat. Nos. 5,228,998 and 6,022,476. Another alternative is to pump air through a submerged piping system to diffusers resting on the bottom of a body of wastewater. The float system can be used to support a medium with a large surface area to support a colony of aerobic bacteria. A built-in piping system supplying diffusers resting on an underwater bottom is expensive to install and maintain and can require draining the wastewater body to repair the aerating system.

This invention improves on aerating systems of the type that pump air into a subsurface region of a body of wastewater. It avoids the expense of both the float-type systems and the built-in bottom resting systems while being versatile, simple, and inexpensive to maintain.

### SUMMARY OF THE INVENTION

Our wastewater aerating system establishes an air compressor on land near a body of wastewater and delivers compressed air through flexible lines out to independent aeration floats that are anchored or moored at chosen locations within the wastewater. Each aeration float receives and distributes compressed air to a plurality of diffusers that are arranged around the aeration float at a predetermined depth below the water surface. This produces a multitude of air bubbles rising from each diffuser upward in regions around each float so that the rising bubbles aerate the wastewater. This provides the oxygen necessary for the aerobic bacteria that already exist within the wastewater to thrive and consume undesirable materials within the wastewater.

The inventive arrangement has several advantages over other methods and devices. Keeping an air compressor and power supply onshore near a body of wastewater makes the equipment accessible and easy to maintain. Delivering the compressed air through flexible lines to independent floats allows the floats to be moved about, the individual lines to be turned on and off, and the flexible lines to be floated on the water surface where they are readily accessible for maintenance. Delivering the air to subsurface diffusers arranged around each float keeps the diffusers off the bottom of the wastewater body and makes them easy to maintain. Floats can be individually lifted out of the water and even taken ashore if necessary; and diffusers can be disconnected from floats for cleaning, repair, or replacement. Altogether, the inventive system significantly economizes over previous ways of aerating wastewater and is highly effective and efficient in capital investment, energy consumption, and results obtained.

### DRAWINGS

FIG. 1 schematically shows the inventive system arranged to deliver compressed air from a shore location to several independent diffuser floats within a body of wastewater.

FIG. 2 schematically shows a plan view of a preferred embodiment of an aeration float usable with the invention.

FIGS. 3 and 4 schematically show alternative preferred embodiments of aeration floats according to the invention.

### DETAILED DESCRIPTION

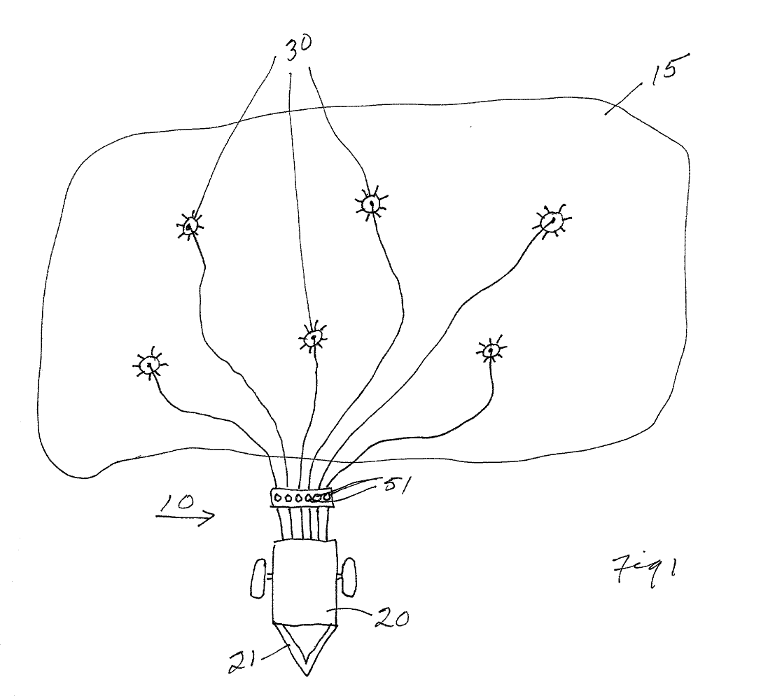

The inventive system 10, as schematically shown in FIG. 1, includes a body of wastewater 15 containing a plurality of aeration floats 30 powered by flexible lines 50 from compressor 20 arranged onshore near wastewater body 15. Compressor 20 is preferably trailer mounted for easy mobility and is connected to a source of electric power (not shown) available at the compressor location alongside wastewater body 15.

Compressed air output from compressor 20 is directed through flexible lines 50 to aeration floats 30, with valves 51 for each of the lines 50 preferably being arranged near compressor 20. Lines 50 are preferably formed of a resilient material not only allowing them to be moved about readily, but also allowing them to be buoyant enough to float on a surface 16 of wastewater 15. Each line 50 preferably leads independently to a respective one of the aeration floats 30 so that each float 30 is independently supplied with compressed air. Valves 51 allow air to be shut off from any individual float 30 for repair of line 50 or float 30. Independence of aeration floats 30 allows each float to be anchored or moored in a desired location and allows floats 30 to be moved about within wastewater body 15.

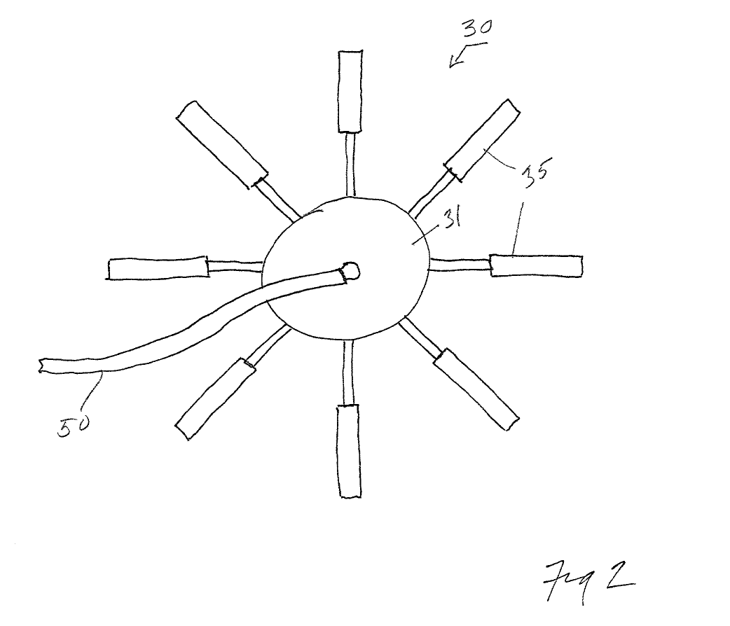

As shown in FIGS. 2-4, each float 30 preferably includes an upper chamber or body 31 arranged to float at water surface 16 and receive compressed air from flexible line 50. Upper body 31 is preferably made hollow to float and be filled with compressed air arriving from line 50. The air received by each float 30 is then directed downward to a predetermined depth below liquid surface 16, where the air is distributed to a plurality of diffusers 35.

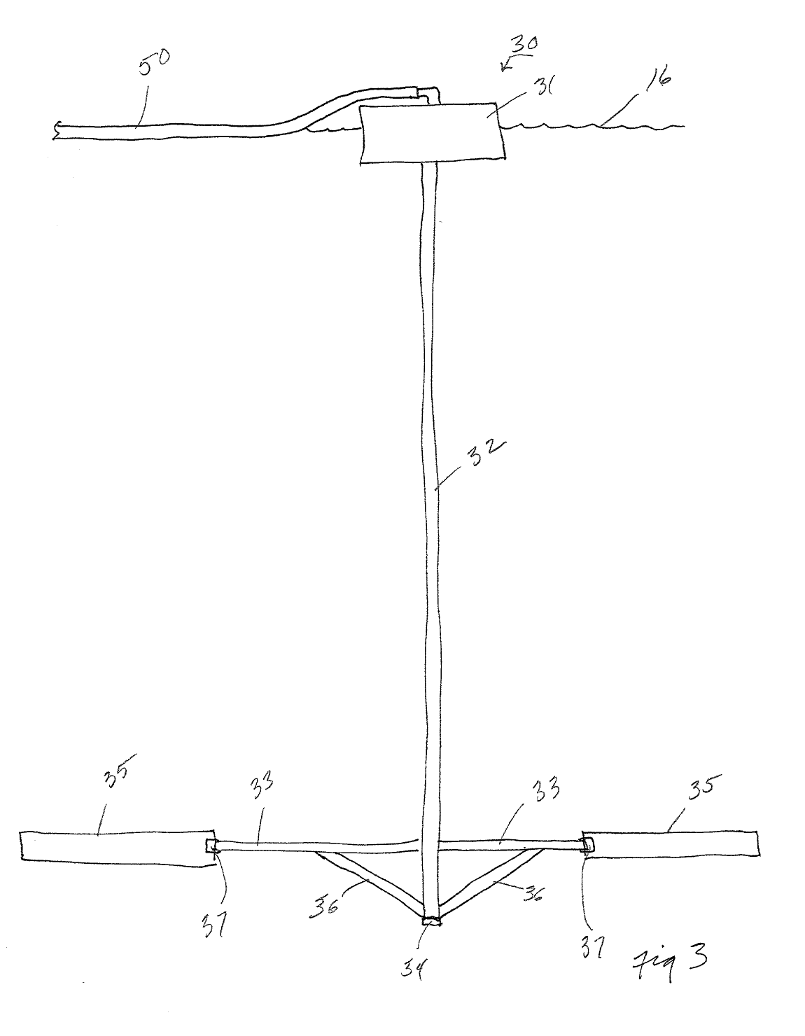

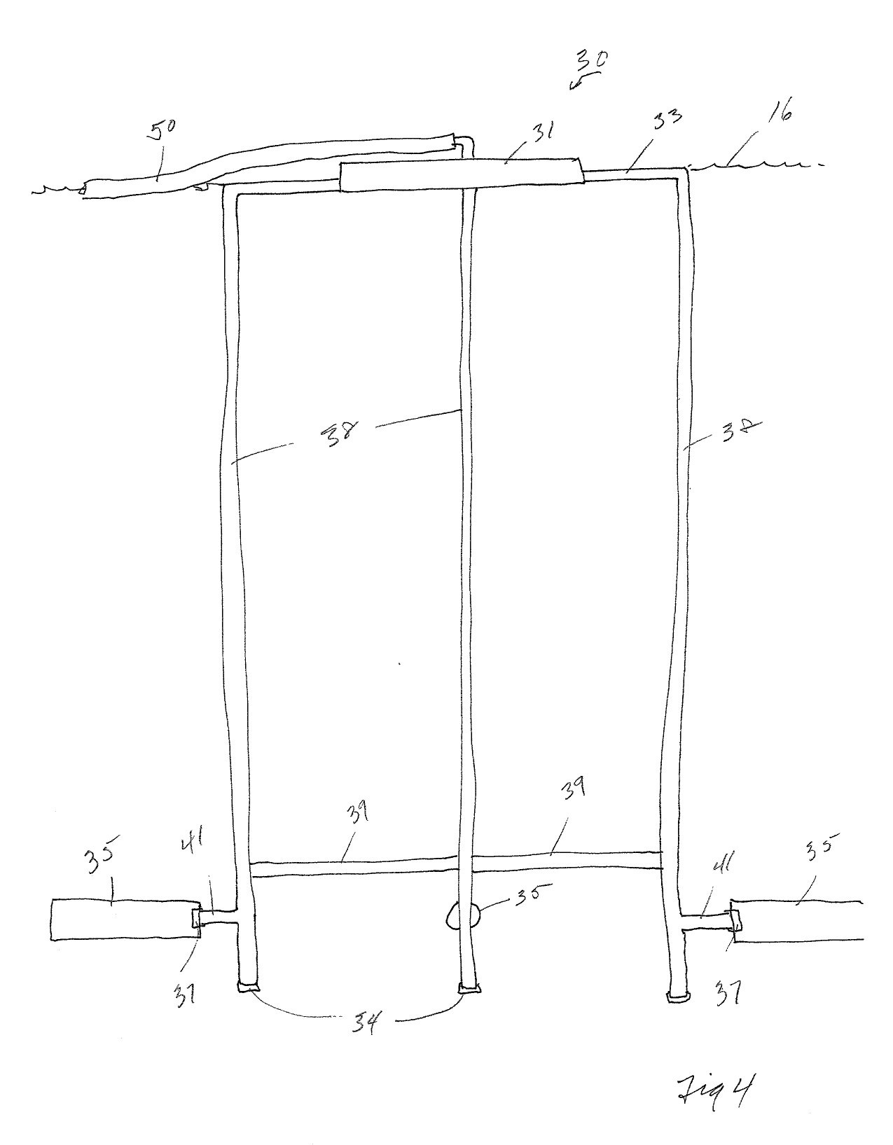

Each float 30 preferably remains upright within wastewater 15 and preferably floats at surface 16 to hold diffusers 35 above a bottom of wastewater 15. This helps keep diffusers 35 clean and undamaged by contact with a bottom of wastewater 15. These objectives can be accomplished by predetermining a depth below wastewater surface 16 where diffusers 35 are deployed. Many different arrangements of float configurations can accomplish this, as is suggested by the different embodiments of FIGS. 3 and 4.

The float 30 of FIG. 3 has a single down pipe 32 directing compressed air down to a subsurface level from surface float 31. At a predetermined depth, down pipe 32 directs compressed air into lateral pipes 33 extending from down pipe 32 to independent diffusers 35. The bottom end of down pipe 32 has an end cap 34, and braces 36 help support lateral pipes 33 directing compressed air from down pipe 32 into diffusers 35.

Diffusers 35 are readily available in several forms, including flat panels and cylinders that are porous enough to direct fine bubbles outward from diffusers 35 into wastewater so that the bubbles rise to wastewater surface 16. Each diffuser 35 is preferably connected to its respective lateral pipe 33 by an easily disconnected connector 37. Connectors 37 can be mating screw threads, spring-loaded connectors, bayonet joints, etc., which allow any diffuser 35 to be easily disconnected from its lateral pipe 33 and cleaned, replaced, or repaired.

Diffusers 35 are also preferably arranged to extend outward around surface float 31 so that bubbles rising from diffusers 35 reach wastewater surface 16 in regions around inlet chamber 31. Guards can be arranged to avoid damaging contact between diffusers 35 and a wastewater bottom or underwater obstructions. Floats 30 are preferably made of aluminum or fiberglass; and aluminum tubing is preferred for light weight so that floats are easily transported, inserted into wastewater 15, and removed from the wastewater or moved about to different positions within the wastewater. Each float 30 can also be anchored or moored in various ways to hold its position within wastewater 15.

The float 30 of FIG. 4 arranges lateral distribution pipes 33 to extend outward from surface float 31 near wastewater surface 15. Then, independent down pipes 38 extend downward from each lateral pipe 33 to a predetermined depth below wastewater surface 16. Braces 39 interconnect down pipes 38 to give them stability, and each down pipe 38 has an end cap 34. A lateral pipe 41 extends from each down pipe 38 to a connector 37 supporting a diffuser 35. The illustration of FIG. 4 schematically shows three out of four of diffusers 35 arranged around surface float 31. As suggested in FIG. 2, though, diffusers 35 can number eight or more for each aeration float 30. The number of diffusers 35 per float 30 depends on the mechanical restraints of size and weight necessary for supporting floats properly within wastewater 15.

Extending down pipes 38 to depths below diffusers 35 helps prevent contact between diffusers 35 and a bottom of wastewater 15. Establishing the predetermined depth for deploying diffusers 35 relative to the known depth of a body of wastewater can also help avoid any damaging contact between diffusers and a bottom of wastewater 15.

We claim:

1. A wastewater aerating system comprising:
a. a float positioned in a body of wastewater;
b. a compressor arranged on a shore next to the body of wastewater;
c. a line delivering compressed air from the compressor to the float;
d. a plurality of diffusers supported by the float and arranged around the float at a predetermined depth below a surface of the body of wastewater; and
e. an air conduit system supported by the float and arranged to receive compressed air from the float and to deliver compressed air downward to the diffusers so that each of the diffusers emits air bubbles at the predetermined depth to rise up through the body of wastewater in regions around the float.

2. The system of claim 1 including a disconnectable connection between each of the diffusers and the air conduit system.

3. The system of claim 1 including a plurality of the lines delivering compressed air from the compressor to a plurality of the floats.

4. The system of claim 1 wherein the line from the compressor to the float is buoyant enough to float at the surface of the body of wastewater.

5. The system of claim 1 wherein the float and the line between the compressor and the float are readily movable to allow changing the position of the float in the body of wastewater and moving the float in and out of the body of wastewater for maintenance.

6. A method of aerating wastewater, the method comprising:
a. arranging an air compressor on a shore alongside a body of the wastewater;
b. delivering compressed air from the compressor through a line to a float moored in the body of wastewater; and
c. directing air from the float to a plurality of diffusers supported by the float and arranged at a predetermined depth below the float in a region around the float so that the diffusers form fine air bubbles that rise upward through the wastewater in regions around the float.

7. The method of claim 6 including directing compressed air from the air compressor through a plurality of the lines to a plurality of the floats.

8. The method of claim 6 including using flexible resin material for the line so that the float is readily movable.

9. The method of claim 6 including floating the line on the surface of the wastewater between the compressor and the float.

10. A wastewater aerating system comprising:
a. an air compressor arranged on a trailer near a body of the wastewater;
b. a plurality of flexible air lines leading from the compressor out into the body of wastewater where the air lines respectively connect to a corresponding plurality of floats so that the air lines deliver air from the compressor to the floats;
c. each of the floats supporting a plurality of diffusers arranged at a predetermined depth below a surface of the body of wastewater in a region around each of the floats; and
d. each of the floats being arranged for directing air received from the compressor downward to the diffusers so that each diffuser produces air bubbles that rise in the wastewater.

11. The system of claim 10 wherein the flexible lines are sufficiently buoyant to float in the body of wastewater.

12. The system of claim 10 including disconnectable connectors connecting each of the diffusers to the float.
